(19) United States
(12) Patent Application Publication
(10) Pub. No.: US 2006/0075440 A1
(43) Pub. Date: Apr. 6, 2006

(54) Trick play of an encrypted video stream

(76) Inventor: Albert Maria Arnold Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/517,478

(22) PCT Filed: Jun. 11, 2003
(86) PCT No.: PCT/IB03/02692

§ 371 Date: Dec. 7, 2004

(30) Foreign Application Priority Data
Jun. 12, 2002 (EP) 02077289.3
Dec. 20, 2002 (EP) 02080633,7

(51) Int. Cl. H04N 7/173

(52) U.S. Cl. 725/88; 725/102

(57) ABSTRACT

A stream of video data is normally played in forward direction. Units of control word information required to decrypt successive segments of the stream are supplied synchronized to the stream. During reverse mode replay sections of the stream are replayed in reverse order. The units of control word information are resynchronized relative to supply of video information. Crossing of boundaries between segments during reverse mode replay triggers supply of selected units. The units are selected so that they contain the control word needed to decrypt a first segment that is normally previous to a second segment that ends at the boundary. Generally, this is a unit that normally starts to be supplied just before or after the start of the first segment.

The invention relates to apparatuses and methods for video recording and replay in a conditional access environment and in particular to trick mode replay, such as fast reverse playback.

European Patent Application No. EP1122728 describes a video recording and reproducing device that is capable of trick mode replay. During trick mode replay, such as fast forward play, a subset of frames in the video data must be replayed in a specific sequence. The device stores an encrypted stream of video data and a map file with pointers to points in storage where selected parts of the video data are stored. For an MPEG encoded video stream for example, pointers to the storage locations of I-frames are stored. For trick mode replay, a selection of frames is determined dependent on the type of trick mode and the map file is used to determine storage locations where the selected frames are stored. The frames are then retrieved from storage, decrypted and used to generate display data.

Encryption usually involves a two level scheme, with control words for decrypting data from the stream and authorization keys for decrypting the control words from the stream. Packets with video data are encrypted so that they can be decrypted with control words. Encryption subdivides the stream into segments, so that the packets from each segment can be decrypted with a different control word. The appropriate control words are included in the stream, more or less synchronously with the segments, so that the control words can be decrypted in time to be used for decrypting the video data. Usually the control word is included many times for each segment, to permit the start of replay at almost arbitrary points in the segment.

Account must be taken of the latency needed for decrypting the control word. To get optimal security against unauthorized access the control word is usually encrypted so that a more complex decryption process is needed than for the video data. Moreover, decryption of the control word is usually performed in a secure device, such as a smart card, that is slower than the hardware used for decryption of the video data. As a result decryption of the control word has to start well before the control word is needed, with the result that the old control word may be overwritten before the last video data with that control word has been decrypted.

Many conditional access systems make allowance for latency by storing two control words, termed an even and an odd control word, one for a current segment and the other for future segment of the stream. The stream indicates for the transmitted control word whether they should be stored as even or odd control words. Thus, the control word for the current segment need not be overwritten when the future control word has been decrypted. Transmission of the future control word starts well before the future segment. Control word selection information is included in each packet in the stream, to indicate which of the control words has to be used to decrypt the packet. Thus, effectively the control word selection information indicates the start of segments of the stream that require a different control word.

Control words also need to be supplied during playback of stored encrypted streams. For normal playback it suffices that control word information accompanies the stream at its original timing relative to the stream. However, during trick play the original timing relations of the stream are lost. If the stream is not to be decrypted in its entirety, it is necessary during trick mode replay to supply the control words in time for decrypting the selected frames that have to be displayed.

European Patent Application No. EP1122728 stores the video information in sectors on a disk. Encrypted information about the control words is stored in the sector headers. When the pointers to the selected video data are retrieved from the map file, the pointers can be used to retrieve the control words as well and after decryption of the control words the associated video information can be decrypted.

In European Patent Application No. EP1122728 retrieval and decryption are performed inside a single apparatus. This makes it easy to synchronize control words and encrypted data, because the latency involved with control word generation is known in advance. In many other applications retrieval has to proceed without knowledge of this latency, for example because the retrieval apparatus has to be able to work with decryption apparatuses from different suppliers of copyright material. In this case it would be desirable that trick mode replay can proceed without knowledge of latency. Moreover, the technique of European Patent Application No. EP1122728 requires storing a control word for each sector, or rather, for each packet of video information. It would be desirable to reduce the required amount of storage.

Among others it is an object of the invention to provide for trick play of an encrypted stream of stored video information that does not require storage of more control word information than in the original stream, while still permitting decryption during trick play.

The invention provides for a method of reverse mode replay of a stored video stream according to claim 1. The invention applies to a stream with a normal replay direction which is reversed in a reverse replay mode, by playing sections that are successively more backward in the normal replay direction (the word “normally” in relation to terms of direction will be used to refer to the normal replay direction, which is opposite to the reverse replay direction). In the streams concerned normally future control words are supplied in units of control word information, synchronized to the stream in advance before the start of segments in which they are needed. Control words for use in decryption of adjacent segment are stored concurrently, so that a selection between the two can be made at any time.

Reverse mode replay involves playing sections of the stream in forward direction and jumping backward between sections. The invention applies to reverse mode replay wherein sections of the stream are skipped. According to the invention during reverse mode replay supply of units of control word information is resynchronized relative to supply of video information. Crossing of boundaries between segments during reverse mode replay triggers supply of selected units. The units are selected so that they contain the control word needed to decrypt a first segment that is normally previous to a second segment that ends at the boundary. The role of future control words and current control words is reversed. Generally, this is a unit that normally starts to be supplied just before or after the start of the first segment.

In an embodiment where each unit contains a first and a second control word for decrypting a normally earlier and later one of a pair of successive segments respectively, the selected unit is selected so that the first control word of the unit is the control word required for decrypting the first segment.

In an embodiment, when playback jumps over a boundary, a test is made whether a section of the stream that is selected for playback starts at one side of a boundary between the segments and crosses back over the boundary in forward direction. The resynchronised unit of control word information is supplied with the start or with the end of the section, dependent on whether the section does not cross back or does cross back respectively. Thus, the unit of control word information is supplied as early as possible, allowing a maximum possible playback rate without interruption. In a further embodiment the units of control word information are sent at the end of the sections after crossing to ensure that usable control words are not overwritten.

These and other objects and advantageous aspects of the method and apparatus according to the invention will be described using the following drawing.

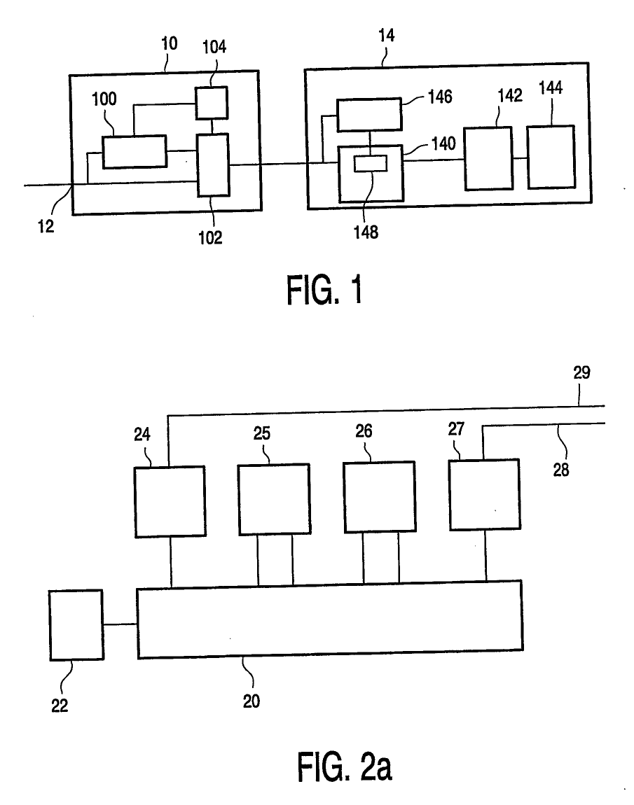

FIG. 1 shows a video information replay system

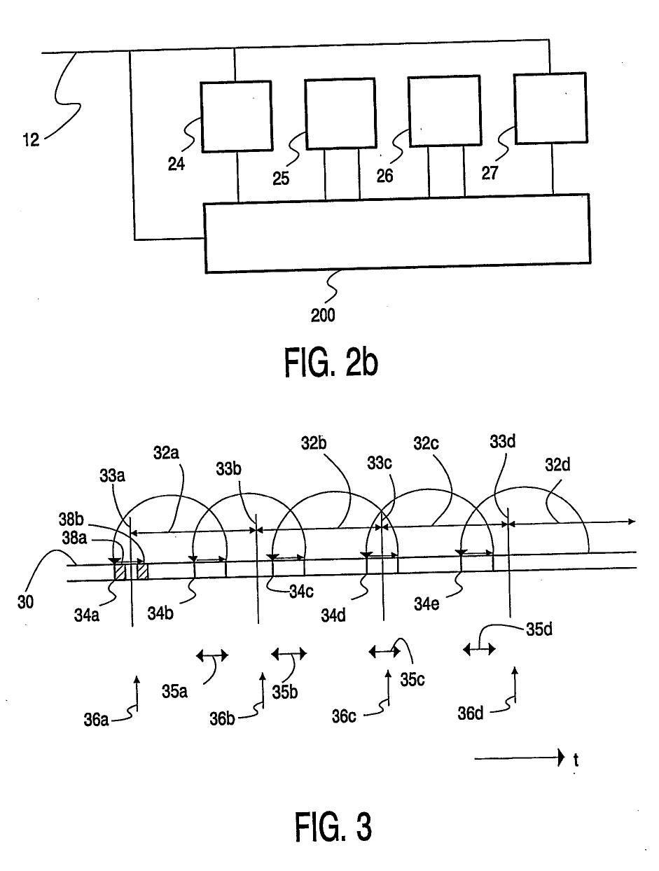

FIG. 2a,b schematically show parts of a recording and replay apparatus

FIG. 3 shows a stream of video data.

FIG. 1 shows a video information replay system. The system contains a stream input 12, a recording and replay apparatus 10 and decoding and display apparatus 14. The recording and replay apparatus contains a recording and replay device 100, a multiplexer 102 and a control unit 104. Control unit 104 has outputs coupled to control inputs of recording and replay device 100 and multiplexer 102. Recording and replay device 100 has an input coupled to stream input 12 and an output coupled to a first input of multiplexer 102. Stream input 12 is coupled to a second input of multiplexer 102. Decoding an display apparatus 14 contains a decryption unit 140, a decoding unit 142 and a display unit 144 in cascade coupled to the output of multiplexer 102. Furthermore decoding an display apparatus 14 contains a control word supply unit 146 with an input coupled to the output of multiplexer 102 and an output coupled to a control word input of decryption unit 140.

In operation a video stream, such as an MPEG stream arrives at stream input 12. In direct play mode multiplexer 12 passes the stream to decoding an display apparatus 14. The stream is composed of packets, most of which contain encrypted video information, optionally for a plurality of programs. Decryption unit 140 decrypts the packets with video information for a program and passes the decrypted video information to decoding unit 142. Decoding unit 142 generates a video signal from the video information, for example by means of MPEG decompression. Display unit 144 uses the video signal to create a video image and/or audio signals. Control word supply unit 146 retrieves encrypted control words from the stream, decrypts the control words and supplies them to decryption unit 140 as keys for decrypting the packets with video information.

During transmission of streams and during normal replay of the stream the control word is periodically changed, typically every ten seconds, so as to prevent that the entire stream could be decrypted once a control word has been determined. Successive segments of the stream require successively different control words to decrypt the video information in the segments. Control words are generally included in the stream at a much higher frequency than the changes between segments (typically every tenth of a second) to enable decryption to start after minimum latency when the stream starts being supplied to stream input 12 from an arbitrary point in the stream, for example after a switch between different channels.

In the stream, control words are supplied in encrypted form. Control words may be transmitted singly or in pairs of control words for successive segments. When control words are transmitted singly, during most of a segment the control word for that segment is transmitted and towards the end of the segment the control word for the next segment is transmitted, allowing latency for decryption of the control word before the start of the next section. Control words supplied in pairs typically include a current control word, which is needed to decrypt a surrounding segment of the stream, as well as a future control word, which is needed for decryption in the next segment. In this way control word supply unit 146 is enabled to start decrypting the future control word, so that it will be available as soon as it is needed, but the control word supply unit is also able to start decrypting the current control word at any time during the stream. Due to timing inaccuracies, the two control words are not always a current and future control word: they may also be a current and a past control word, or a future and further future control word.

The stream contains information to indicate which of the supplied control words has to be used as current control word. This information is typically in the form of a bit supplied with each packet to indicate which of the pair of supplied control words is the current control word. This information makes it possible to separate on one hand timing of changes of the transmitted control words in the stream and on the other hand the timing of switching between control words. Thus, transmission of the future control word can start at any point in the stream while the current control word is valid. A new control may start being supplied soon after or before the start of the segment that precedes the segment in which that control word is needed. At the latest the new control word should start being supplied sufficiently in advance of its segment to allow time for decryption of the control word.

Decryption unit 140 typically contains storage elements 148 with space for two control words for decrypting adjacent segments of the stream respectively. These control words are received from key supply unit 146. Information supplied with the stream controls in which of storage element 148 received control word should be stored, when that control word is supplied. Information from each packet controls from which storage locations the control word is used to decrypt the packet. However, without deviating from the invention, the control words may be stored in key supply unit 146, to be supplied for a packet upon specific request and selection of control words may be controlled by information outside the packets.

Recording and replay device 100 records the stream when signalled to do so by control unit 104. At a later time recording and replay device 100 replays information from the stream for use by decoding an display apparatus 14, when signalled to do so by control unit. Control unit 104 can signal replay in various modes: in a normal replay mode, or in any one of a number of trick play modes, such as still, fast forward, reverse or fast reverse. In the normal replay mode the stream may be replayed from recording and replay device 100 basically as it was received from stream input 12. In the trick replay modes recording and replay device 100 rearranges timing of control words.

FIG. 2a schematically shows part of a recording and replay apparatus that is arranged to support replay in trick play mode. The apparatus contains a replay control unit 20, a mode selection unit 22 and storage elements 24, 25, 26, 27: a first storage element 24 for pairs of encrypted control words, a second storage element 25 for information that indicates where the control word required for decryption changes in the stream, a third storage element 26 for pointer information and a fourth storage element 27 for packet with video data. The pointers in third storage element 26 point to locations where selected packets (such as MPEG I frames) are stored in fourth storage element 27. Similarly the information in second storage element 25 typically is expressed in terms of pointers to locations in fourth storage element 27.

Although storage elements 24, 25, 26, 27 are shown separately, it will be understood that combinations of these elements, or even all these elements, may be implemented using a single storage device, such as a magnetic disc or a semi-conductor memory, using different storage locations in such a device. Replay control unit 20 is shown coupled to storage elements 24, 25, 26, 27. First storage element 24 and fourth storage element 27 are coupled to outputs 28, 29 for video data packets and control word information respectively. Outputs 28, 29 are ultimately coupled to the decoding and display apparatus (not shown). This coupling may be through stream forming unit (not shown) that recombines control word information and video packets into a complete stream which is fed to a single input of the decoding and display apparatus, or video packets and control word information may be fed through separate inputs. Mode selection unit 22 is coupled to replay control unit 20.

FIG. 2b schematically shows part of a recording and replay apparatus that is arranged to support recording. A recording control unit 200 is coupled to storage elements 24, 25, 26, 27 and to data stream input 12. First and fourth storage element 24, 27 are coupled to stream input 12.

In operation during recording, the recording and replay apparatus stores an incoming video data stream, or selected parts thereof which include video packets for at least one program, in fourth storage element 27. The packets are stored in encrypted form as received from stream input 12. During recording, recording control unit 200 detects units of control word information in the incoming video stream and causes these to be stored in first storage element 24. Preferably, recording control unit 200 detects whether the control word information is new or merely a copy of earlier information and causes only new control word information to be stored (In MPEG streams for example, contain a separate tableID toggle which changes each time when new control word information is transmitted. This toggle signal may be used to trigger storage). In storage the stored control word information may be accompanied with pointer information to indicate the position in the stored incoming stream where the control word information occurred.

Furthermore, recording control unit 200 detects from the incoming stream what control information should be used for which part of the stream. Typically this involves testing a bit that signals whether a first or a second control word from the control word information should be used. Recording control unit 200 records changes of selection of the control word in second storage element 25, for example in the form of pointers to positions in the stored stream where the changes occur and pointers to the control word information that was valid at the time of the change.

Finally recording control unit 200 detects selected positions in the stream that may play a role during trick mode replay. For example, these positions include the start of a section of the stream that contains I-frames information in an MPEG stream (that is, video frames which can be decoded independent of other video frames). Recording control unit 200 stores information for selectively retrieving the stream starting from these positions in third storage element 26. Dependent on the way information is coded in the incoming stream it may be necessary to decrypt at least part of the incoming stream in order to search for the relevant positions.

Although, as described, determination and storage of pointer information etc. occurs simultaneously with recording, it will be understood that the pointer information etc. may also be compiled partly or wholly later, after recording or may be transmitted with the incoming stream, so that determination of the pointers etc. during reception is not necessary.

During replay mode selection unit 22 signals whether and in what mode replay control unit 20 should replay stored data. In a normal replay mode, a data stream is reconstructed substantially as it was received as the incoming stream, control word information accompanying the video packets with a timing as in the incoming stream.

FIG. 3 shows a stream of video data as a function of time progressing from left to right in the figure. The stream is symbolized by a band 30. Stream 30 contains successive packets (only two packets 38a,b shown explicitly, but is should be understood that the stream contains an almost continuous series of successive packets). The packets include packets with video information. The packets with video information are generally encrypted and a control word is needed to decrypt the packets. Stream 30 is shown subdivided into segments 32a-d; in each segment 32a-d a different control word is required to decrypt the packets with video information. Between segments 32a-d boundaries 33a-d have been indicated.

In stream 30 items of control word information are transmitted repeatedly. Each item of control word information contains one or more control words, fore example a current control word that is required to decrypt packets in the segment 32a-d in which the item is included in the stream and a future control word for decryption in the subsequent segment 32a-d. The points in stream 30 where new items of control word information start being transmitted in the incoming video stream are indicated by arrows 36a-d. The location of the first new items generally does not coincide with boundaries 33a-d. By way of example, transmission of new items starts shortly after the boundaries 33a-d, each item containing a current control word and a future control word, the latter applying to the segment after the next boundary 33a-d. The only constraint on the start of transmission of new items is that a relevant control word for a particular segment 32a-d should start being transmitted during the preceding segment 32a-d with sufficient latency before the start of the particular segment 32a-d where it is needed to permit decryption prior to the start of the segment. In another example, where only one control word is transmitted in each item, the start of transmission of the item with the control word for a segment 32a-d starts only a latency period before the segment where this control word is needed.

Information in stream 30 indicates the location of boundaries 33a-d, for example by means of a selection bit for each packet, to indicate which of the transmitted control words should be used for decryption.

During reverse playback replay control unit 20 causes selected sections 35a-d of stream 30 to be fed to recording and replay apparatus 10. In general the selected sections 35a-d may contain one or more packets of data (only two packets 38a,b shown), so that it is possible that more than one control word is needed to decrypt packets in a single section 35a-d if the section spans a boundary 33a-d; of course different control words may also be needed to decrypt different sections. The data within the selected sections 35a-d is fed in forward temporal order (i.e. as it occurs in stream 30 from left to right). But the temporal order of feeding successive ones of the selected sections 35a-d is in reverse order, i.e. the rightmost section 35d is fed first, followed by the second rightmost section 35c and so on. This order of playback is illustrated by arrows in FIG. 3, looping back to the start 34a-d of each section 35a-d that is replayed, and pointing forward within the sections 35a-d. The selected sections 35a-d contain for example I-frames of an MPEG stream.

During reverse playback replay control unit 20 accesses information from third storage element 25 to select the sections 35a-d that will be played back. For an MPEG type of stream, these sections may start at the start of I frames in the stream, i.e. frames that from which a video signal can be decoded without reference to other frames. Furthermore, dependent on the required replay speed a bus-selection of available starting points 34a-d may be made to select the sections 35a-d that have to be played back. Replay control unit 20 uses the selected information from third storage element 25 to control fourth storage element 27 to feed packets from the selected sections to decoding and display apparatus 14.

Replay control unit 20 also controls selection and timing of feeding of items with control information from first storage element 24. During reverse replay the timing of these items relative to the packets with video information differs from the original timing in the original stream received at stream input 12. Replay control unit 20 uses information about the location of boundaries 33a-d to determine when the jumps back to the starting points 34a-d of the replayed sections cross boundaries 33a-d. Feeding of new items is triggered in association with crossings. In general replay control unit 20 is not triggered to feed new item of decryption information when the jump from one section 35a-d to a previous section 35a-d for later play involves two sections 35a-d that belong to the same segment 32a-d.

For each crossing of a boundary 33a-d replay control unit 20 selects a particular item of control word information for supply to decoding and display apparatus 14. Replay control unit 20 selects that item that contains the control word that is needed for decryption of the segment 32a-d preceding the segment 32a-d that ends at the boundary that is being crossed. In case of FIG. 3, upon crossing boundary 33d for example to replay from position 34e, the item of control word information that started to be transmitted at a position 36b near boundary 33b two segments 32b, 32c earlier is selected for feeding to decoding and display apparatus 14. In another example, when the items contain single control words starting before the boundary 33a-d after which the control words, the control word for started before two boundaries earlier is selected. In general, an item is selected that is the last to start being supplied more than a latency time before the end of the segment that normally precedes the segment that ends at the boundary that triggers supply of the selected item.

Thus, in case of items with current and future control words, the control word in this item which used to function as current control word in the original stream now acts as future control word for use later on during reverse playback and the control word in this item which used to function as future control word acts as current control word. In case of items with a single control word a normally past control word is selected.

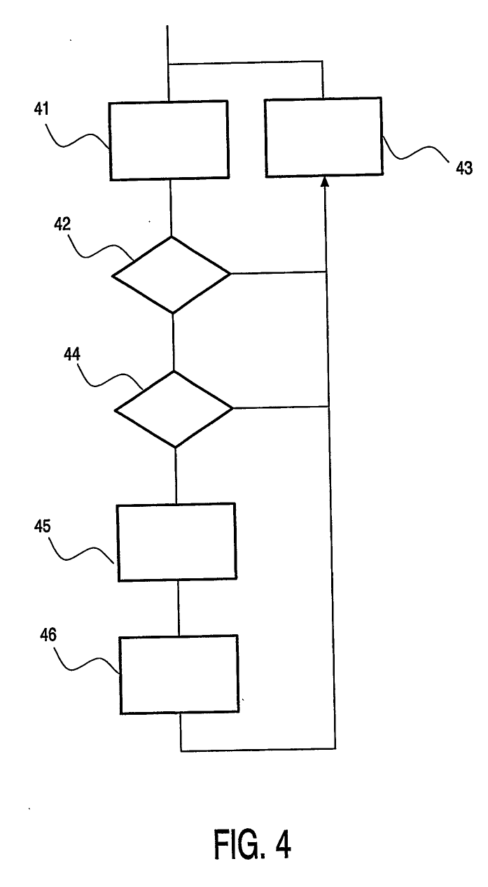

FIG. 4 shows a flow-chart of an embodiment for feeding items of control word information. In a first step 41 of this embodiment replay control unit 20 selects the starting point 34a-d of the section that has to be replayed next. In a second step replay control unit 20 tests whether the jump from the end of the previous section 35a-d to the selected starting position 34a-d crosses a boundary 33a-d. If not a third step 43 is executed, feeding the section 35a-d to decoding and display apparatus 14 starting from the selected starting point 34a-d. If the jump crosses a boundary 33a-d a fourth step 44 is executed, to test whether the section 35a-d that has to be played from the selected starting point 34a-d crosses a boundary 33a-d. If so third step 43 is executed without sending an item of control word information. If the section 35a-d does not cross a boundary 33a-d, a fifth step 45 is executed, selecting the relevant item of control word information that contains the control word for the next preceding segment 32a-d (e.g. the item that starts being transmitted from near two boundaries 33a-d earlier).

In a sixth step 46 the selected item is fed to decoding and display apparatus 14 and subsequently the third step 43 is executed. However without deviating from the invention the item may be fed with some delay, so that it is fed during feeding of the section 35a-c in the third step.

By means of the fourth step 44 it is prevented that the preceding control word, which is needed for decrypting the end of the section 35a-d is overwritten prior to completion of the section, while on the other hand the item is fed as soon as possible when the section 35a-d does not cross the boundary 33a-d. This permits a maximum possible replay speed. It will be appreciated that this effect may be achieved by other processes than that shown in FIG. 4, for example by testing in the second step whether the jump between the starting points 34a-d of the successive sections 35a-d crosses a boundary, and in that case feeding the selected item of control word information either at the start of the section or at its end depending on whether the section crosses a boundary 33a. The maximum speed of reverse replay (i.e. the maximum distance between successively replayed sections 35a-d) is determined by the time needed to decrypt control words. With the present technique it is not possible to use jumps that cross more than one boundary 33a-d without causing interruptions in decryption.

In an alternative embodiment replay control unit 20 feeds the selected item of decryption information at a jump only if there is a boundary 33a-d between the ends of the sections 35a-d between which the jump occurs. Thus it is also prevented that the item of control word information is replaced while it is still needed for a final part of the section 35a-d to be played. However an unnecessary delay in delivery of the item of decryption information when the section 35a-d does not cross a boundary occurs. This reduces the maximum reverse replay speed.

When it is known that the time needed for decrypting the control word is longer than the maximum length of time needed to feed a section 35a-d to decoding and display apparatus 14, the item of control word information may also be fed substantially simultaneously with the start of the section. However, this assumes a restriction on the speed of decoding and display apparatus 14, which make this embodiment less generally applicable.

Preferably special measures are taken at the start of reverse mode replay, if it is desired that a minimum of delay occurs during switching. In this case at least one item of control word information is supplied, triggered by the start of reverse mode replay. The item is supplied before supplying the first section with one or more packets of video information. Preferably, the item of control word information is supplied that contains as future control word the control word for an initial segment that contains the first section (or at least the end of the first section). Alternatively, supply of a first and second item of control word information is triggered at the start of reverse mode replay: first the item of control word information that contain the control word for the initial section as current control word (not as future control word), followed by a second item that contains the control word for the segment before the initial segment as current control word (not as future control word). Thus, trick mode replay is compatible both with streams that contain control words singly in the items and with streams that contain the control word in pairs.

Replay control unit 20 may be implemented for example as a microcontroller programmed to performs the required selections and detections and to control replay. However, as an alternative a plurality of processors may be used to perform different actions such as selection and detection of crossings, or dedicated hardware selectors and detectors (not shown) may be used for part or all of these functions.

As described the invention provides for conversion of an original video data stream into a reverse played back data stream. By storing addressable information about boundaries between segments of the stream that require different control words and about items of control word information, timing and selection of supply of control word information is controlled so that the reverse play back video data stream can be decrypted by a conventional decoding and display apparatus.

It will be appreciated that the various embodiments described are provided by way of example. For example, although MPEG streams and play back of I-frames in reverse succession has been used as an example, it will be understood that other types of stream may be used, as well as other ways of selecting sections of video data that are played back. Although it has been assumed that the control words for the selected sections are the same as for the surrounding segments, different control words may in fact be used for the sections. Thus, for example, an information provider may control selectively whether trick mode replay or non-trick mode replay is permitted, subject to a subscription fee. In fact the control words may be changed on recording, by reencrypting the available sections.

Furthermore, although memory elements have been shown that permit selection of sections with information from one element, followed by testing for jumps across boundaries using information from another element and selection of the corresponding items of control words from another element, it will be understood that other ways of gathering the required information may be used. If the apparatus is sufficiently fast, for example the relevant information may be retrieved by searching from the stored stream.

1. A method of reverse mode replay of a stored video stream, wherein successive control words are required for decrypting normally successive segments of the stored video stream, control word information being supplied in units, each unit containing a control word required for decrypting a respective segment of the stored video stream, the method comprising
supplying selected sections of video information in reverse play back mode;
detecting a crossing position, where said supplying involves backward jumps across a boundary between segments;
selecting one of the units of control word information that contains the control word required for decrypting a first segment normally previous to a second segment that extends up to the boundary;
resynchronizing supply of the units of control word information relative to supply of the sections of video information, supply of said one of the units of control word information being triggered by detection of the crossing position;
concurrently storing at least two control words supplied for use in decrypting adjacent segments.

2. A method according to claim 1, the method comprising
storing boundary information that identifies control word change locations at boundaries between the segments in the stream;
selecting a series of section start locations that are successively earlier in a normal sequence of the stream, successively replayed sections starting at successive ones of the section start locations in the series, whereby each section start location is associated with a time point of replay, data from each section being replayed in normally forward direction;
using the boundary information to determine the crossing positions in the series, where jumps across boundaries occur;
retrieving respective ones of the units for respective ones of the crossing points, so that the respective one of the units retrieved for the respective one of the crossing point contains, as control word, the control word required for decrypting the first segment for the respective one of the crossing points;
supplying the respective ones of the units, synchronized to respective time points of section start locations at the respective ones of the crossing positions.

3. A method according to claim 1, wherein each unit contains a first and a second control word for decrypting a normally earlier and later one of a pair of successive segments respectively, said selecting comprising selecting said one of the units of control word information so that the first control word of the unit is the control word required for decrypting the first segment.

4. A method of reverse mode replay according to claim 1, the method comprising testing, for the crossing point, whether the section starting at the first section start location after the crossing point extends across the boundary and, if so, delaying supply of said one of the units substantially until the end of replay of data from the section and if not supplying the respective one of the units substantially together with a beginning of replay of the section.

5. A method of reverse mode replay according to claim 1, supplying said one of the units only after replay of data from the section that starts from the section start location following the crossing point.

6. An apparatus for playing a stored video stream, the apparatus supporting a reverse replay mode, the stored video stream requiring successive control words for decrypting normally successive segments of the stored video stream, control word information being supplied in units, each unit containing a control word required for decrypting a segments of the stored video stream, the apparatus comprising
a storage device for storing the stored video stream;
an output for replaying at least part of the stored video stream from the storage device;
a replay control unit that is arranged to
cause supply of selected sections of video information in reverse play back mode;
detect a crossing position, where said supplying involves a backward jump across a boundary between segments;
select one of the units of control word information that contains the control word required for decrypting a first segment normally previous to a second segment that extends up to the boundary;
resynchronize supply of the units of control word information relative to supply of the sections of video information, supply of said one of the units of control word information being triggered by detection of the crossing position, for concurrent storage of at least two control words supplied for use in decrypting adjacent segments.

7. An apparatus according to claim 6, the apparatus comprising
a storage element for addressably storing boundary information that identifies control word change locations at boundaries between the segments in the stream, the replay control unit being arranged to
select, in the reverse replay mode, a series of section start locations that are normally successively earlier in the stream;
replay data from sections of the stream, successively replayed sections starting at successive ones of the section start locations in the series, whereby each section start location is associated with a time point of replay, data from each section being replayed in forward direction;
use the boundary information to determine crossing positions in the series, where jumps across boundaries occur;
retrieve respective ones of the units for respective ones of the crossing points, so that the respective one of the units retrieved for the respective one of the crossing point contains, as control word, the control word required for decrypting the first segment for the respective one of the crossing points;
supply the respective ones of the units, synchronized to respective time points of section start locations at the respective ones of the crossing positions.

8. An apparatus according to claim 6, wherein each unit contains a first and a second control word for decrypting a normally earlier and later one of a pair of successive segments respectively, and wherein the replay control unit selects said one of the units of control word information so that the first control word of the unit is the control word required for decrypting the first segment.

9. An apparatus according to claim 6, the replay control unit being arranged to test, for the crossing point, whether the section starting at the first section start location after the crossing point extends across the boundary and, if so, delaying supply of said one of the units substantially until the end of replay of data from the section and if not supplying the respective one of the units substantially together with a beginning of replay of the section.

10. An apparatus according to claim 6, wherein the replay control unit is arranged to supply two units of control word information triggered by the start of reverse mode replay, the two units being selected so that the first unit contains a first control word needed for decrypting the initial segment that contains a first section for reverse replay and the second unit contains a second control word for decrypting a further segment normally immediately preceding the initial segment, but no control word that changes the first control word.
